(19) United States
(12) Patent Application Publication
(10) Pub. No.: US 2003/0026375 A1
(43) Pub. Date: Feb. 6, 2003

(54) Apparatus for transmuting nitrogen 14 into carbon 14

(76) Inventor: Robert Wallace Beckwith, Clearwater, FL (US)

Correspondence Address: Robert W. Beckwith, 2794 Comden Road, Clearwater, FL, 33759, US

(21) Appl. No.: 10/178,959

(22) Filed: Jun. 25, 2002

Related U.S. Application Data
(63) Continuation-in-part of application No. 09/572,615, filed on May 17, 2000.

(51) Int. Cl. G21G 1/10

(52) U.S. Cl. 376/194

(57) ABSTRACT

Nitrogen 14 is fed by pressure differentials in a continuous process within a microwave cavity in which the atoms are held in a fixed direction of spin while electromagnetic energy resonant with nitrogen 14 converts protons into neutrons thus transmuting nitrogen 14 into carbon 14.

This invention is a continuation in part of U.S. patent application Ser. No. 09/572,615 of the same name.

### BACKGROUND OF THE INVENTION

The electric utility industry is currently using superconductors which require expensive cryogenic cooling. Please see Reference 1: High-Temp Superconducting Cable Turns a Corner, IEEE Spectrum magazine December 2001, pages 18, 19 & 20.

Carbon 14 (C14) in the form of nanotubes is believed to be a superconductor of great potential value to the electric utility industry having a temperature range of superconductivity from near absolute zero to the burning temperature of carbon. In addition, the great reported strength of C14 nanotubes is of potential importance to the design of electric power lines, generators, motors, and transformers.

An inexpensive source of C14 is therefore needed.

### REFERENCES

1. IEEE (Institute of Electrical and Electronic) Spectrum magazine, December 2001, pages 18, 19 & 20.

2. THE CRC HANDBOOK OF CHEMISTRY AND PHYSICS, 78th edition pages 1-1, 1-4, 11-42, 11-43.

### SUMMARY OF THE INVENTION

Nitrogen 14 is passed by pressure differentials through a resonant microwave cavity excited from an antenna at the precise resonant frequency of N14 atoms. Location of N14 atoms are controlled in a first direction by the flow through the chamber. Directions of spin of N14 atoms are controlled in a second direction by a magnetic H field and in a third direction by an electric E field. Thus held in three dimensions, N14 atoms absorb microwave energy as they pass through the microwave cavity so as to cause one proton to change into a neutron as required to form atoms of C14. C14 atoms release one valence electron when formed. These electrons are measured as electric currents useful for monitoring operation of the inventive apparatus.

### BRIEF DESCRIPTIONS OF THE DRAWINGS

FIG. 1 Directions of the three dimensions of space, x, y and z as used herein.

FIG. 2a A diagram of an N14 to C14 transmuting device having a magnetic (H) field downward in the z direction and an electric (E) field inward in the x direction.

FIG. 2b The cross section of the transmuting device of FIG. 2a.

FIG. 3 An electromagnet and supply for producing the H field.

### DETAILED DESCRIPTION OF THE PREFERRED EMBODIMENT

TABLE I
Let us first look at comparisons of properties of N14 and C14:

| | Nitrogen 14 | Carbon 14 |
|---|---|---|
| Atomic weights | 14.00307401 | 14.00324199 |
| | (Ref. 1, p11-43) | (Ref. 1, p11-42) |
| Spin | 0 | +1 |
| Atomic number | 6 | 7 |
| Protons | 7 | 6 |
| Neutrons | 7 | 8 |
| Inner electrons | 2 | 2 |
| Outer electrons | 5 | 4 |

As we go down the table we see features of the process of transmutation from atoms of nitrogen 14 to atoms of carbon 14. It is clear that it is necessary to convert one proton of N14 into a neutron to form an atom of C14. Also note that one outer electron will be released by the transmutation of each atom of N14 into C14.

It is convenient to measure the current produced by the ejection of the unneeded electron as an indication of the production of C14. It is also clear that the current will be at the lower limit of present technology for measuring direct current with no possibility for generation of useful electric power.

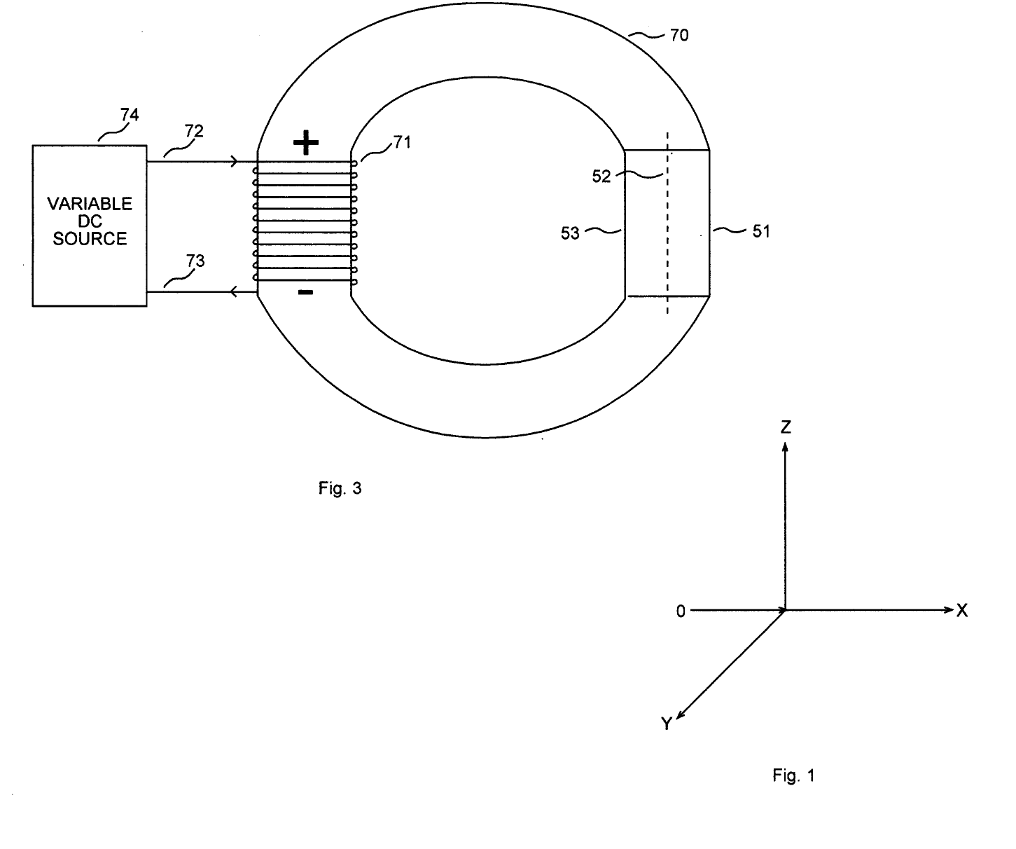

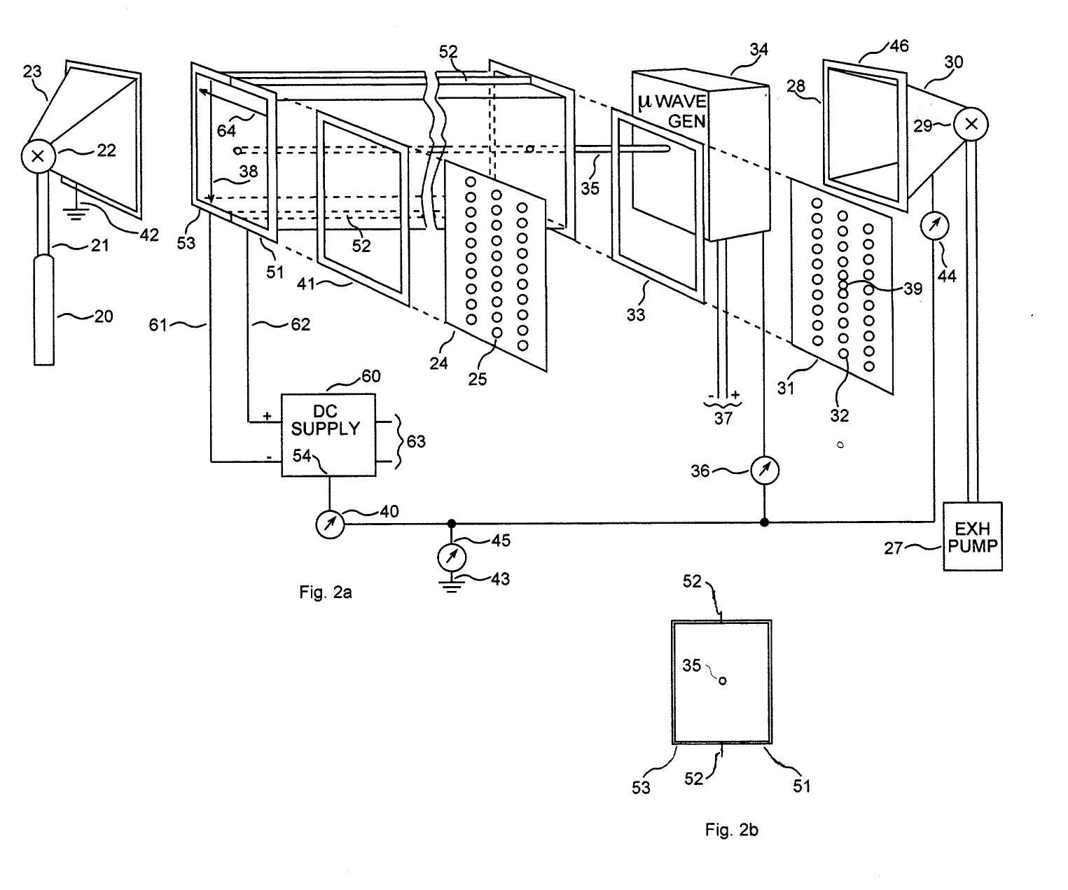

The transmuting device of FIG. 2a uses three dimensional directions as shown in FIG. 1. The device utilizes a microwave cavity having an upward dimension z, a sideways dimension y and a lengthwise dimension x. N14 flows through cavity 51/53 in the x dimension as a result of controlled gas pressure differentials starting with a conventional high pressure nitrogen tank 20. Selectively nitrogen gas in this tank may be purified to be especially free of common carbon 12. The gas passes through pressure regulator 22, through an expansion chamber 23, and through gas distribution plate 24 into microwave cavity 51/53. The gas exits cavity 51/53 though second plate 31, through microwave generator 34 and into collection chamber. The gas then passes through pressure regulator 29 and into an exhaust pump 27. Plates 24 and 31 serve the purpose of producing a laminar flow of gas through the microwave cavity 51/53.

FIG. 2b shows a cross section of microwave cavity 51/53 illustrating construction of the cavity in two parts 51 and 53 insulated by film 52 so as to permit placing an electric field in the y direction from front to back of cavity 51/53. DC power supply 60 places a positive charge on front part 51 of the microwave cavity via electrical connection 62 and a negative charge on back part 53 of the microwave cavity via electrical connection 61. An electric field 64 is thus produced flowing inward from the front of the cavity. Cavity 51/53 is electrically insulated from chamber 23 by insulating film 41. Electrically insulating film 41 forms a distributed capacitance to effectively close cavity 51/53 by plate 24 so as to reflect microwaves as required for cavity 51/53 resonance.

FIG. 3 illustrates an electromagnet consisting of high permeability iron 70 excited by direct current in winding 71 for producing a magnetic field 38 downward through across cavity 51/53 of FIG. 2a. DC current for winding 71 is fed by conductor 72 from adjustable DC supply 74 with current returned to supply 74 over conductor 73.

The assignment of directions of the magnetic field, H, and the electric field, E, is arbitrary, there being four combinations (choices) of the two directions. The choice illustrated herein, with the positive pole of the magnetic source above cavity 51/53 and the positive source of electric field connected to the front of cavity 51/53, places the spin direction of N14 protons in a quadrant upward and outward towards the front of cavity 51/53.

Returning to FIG. 2a, plate 31 is connected to microwave generator 34 by its mechanical mounting as one surface of generator 34. Electrically insulating film 33 forms a distributed capacitance to effectively close cavity 51/53 by plate 31 so as to reflect microwaves as required for cavity 51/53 resonance. Microwave generator 34 drives multiple quarter wave length excitation antenna 35 which passes through plate 31 using insulating hole 39. C14 atoms when first produced will carry an initial negative charge due to the valence electron produced by the transmutation. These are therefore effectively negative C14 ions and will be attracted to the positively charged front half 51 of the microwave cavity. Electrons deposited on front half 51 will pass to ground through ammeter 40 from a neutral voltage point 54 in DC supply 60. Front half 51 is periodically disassembled and C14 atoms removed. Processes for safely removing C14 for further study and use will be applied. Plate 31 is connected by contact to the housing of microwave generator 34. Antenna 35 has an internal DC current return to the casing of microwave generator 34. C14 ions created at the vary end of their passage through cavity 51/53 may therefore deposit on antenna 35 and plate 31 producing a second DC current through ammeter 36. Microwave generator 34 is relatively open for passage of gas into chamber. Any C14 ions that should pass through holes in plate 31 will deposit on chamber 30 producing a third DC current through ammeter 44. Summing ammeter 45 gives an overall indication of the production of C14 measured by ammeters 36, 40 and 44 indicating the total production of C14. Non electric vacuum gages, not shown, are included to monitor the pressures in input manifold 23, cavity 51/53 and output manifold 30.

An electromagnetic wave at the resonant frequency of N14 causes protons in N14 atoms to absorb energy somewhat like winding a spring. When sufficient energy is stored in a proton of an atom of N14 to convert it into a neutron the N14 atom snaps in a quantum jump therefore becoming an atom of C14. As the transmutation occurs a quantum decrease in frequency of spin occurs due to the increase of the atomic weight of C14 as compared with N14 as given in Table I above. This gives a lower resonant frequency of C14 than for N14. The C14 atoms therefore no longer absorb energy from the electromagnetic field produced by microwave generator 34 which is controlled to the precise resonant frequency of N14.

Since N14 atoms are naturally held together in pairs it is expected that C14 atoms will be produced that are likewise bound together in pairs. This may distinguish them from naturally occurring C14.

### Calculations of C14 Production by Current Measurements

As produced by the apparatus described in FIG. 2.

Assume that a DC current of 0.1 microamperes (10⁻⁷ amperes) is obtained.

An Ampere is one coulomb per second.

An electron is 1.602*10⁻¹⁹ coulombs. (Ref. 1, p1-1)

The electrons per second at one ampere of current is then:

1) 1/(1.602*10⁻¹⁹)=6.24*10¹⁸ electrons per second.

Since there is one electron per atom of C14 produced

2) 6.24*10¹⁸*10⁻⁷=10¹¹ atoms of C14 per second which can be detected at a current of 10⁻⁷ amperes.

The number of atoms per gram of C14 produced is found starting with Avogadro's number: 6.02*10²⁶ atoms in 14 kilograms of C14. (Ref. 1, p1-1)

The number of atoms in one kilogram is then:

3) 6.02/14=0.43*10²⁶ atoms per Kg or 0.43*10¹⁷ atoms per microgram.

Assuming then that the weight, W, of C14 can be converted per second:

4) W=(6.24*10¹¹)/(0.43*10¹⁷)=14.5*10⁻⁶ micrograms per second.

The total output current of the inventive device is thus preferred as the measure of transmutation of N14 into C14 as compared to any attempt to detect C14, as it is produced, by weight.

### Conservation of Energy in the Transmutation of N14 to C14

It is also useful to observe the conservation of energy in the overall process of first adding energy for transmutation of nitrogen 14 into carbon 14 and secondly the release of the added energy in the decay of C14 back into N14:

Nuclear masses:

C14=14.003241982 Atomic Mass Units (AMUs)

N14=14.003074002 AMU

The difference in AMU is:

4) C14−N14=0.000167980=1.67980⁻⁴ AMU One AMU=1.6605402⁻²⁷ kG (Ref. 1, p1-1)

The difference in mass is then:

5) (1.67980⁻⁴ AMU) (1.6605402⁻²⁷)=2.7893754⁻³¹ kG

Using E=mc² the gain in energy of the C14 is:

6) (2.7893754⁻³¹)(2.99792458*10⁸)²=2.5069656*10⁻¹⁴ Joules

One electron volt=1.60217733 10⁻¹⁹ Joules Ref. 1, p1-1)

The gain in energy in transmutation of one atom of N14 into an atom of C14 is:

7) (2.5069656*10⁻¹⁴)/(1.60217733*10⁻¹⁹) =156,472 electron volts

From the Table of Isotopes the decay mode of C14 back into N14 yields: (Ref.1, p11-42)

8) 0.15648 meV=156,480 electron volts

The difference of 8 electron volts between 7) and 8) may be explainable as representing neutrinos emitted in the radioactive decay of an atom of C14. The closeness of the two numbers fulfills the conservation of energy in the overall process and confirms C14 decay to N14, not to C12 as popularly believed by some.

### Cost of Energy Required for Production of C14 from N14

The energy required for production of C14 from N14 can be determined:

From above there are 0.43*1026 atoms per Kg of C14. Since an ampere is one coulomb per second and an electron is 1.602*10⁻¹⁹ coulombs, then the energy that must be added in the transmutation process is:

9) (0.43*10²⁶) (156,472)=6.73*10³⁰ electron volts per kG.

It is useful to estimate the cost of producing C14 in possible production equipment developed through use of the present invention:

One watt second=1 volt*1 ampere*1 second.

One watt second=one coulomb volt.

There are 6.24*10¹⁸ electrons per coulomb.

Therefore 1 watt second=6.24*10¹⁸ electron volts.

The energy in one C14 atom=1.56*10⁵ electron volts.

The number, N, of C14 atoms produced by one watt second of energy is:

10) N=(6.24*10¹⁸)/(1.56*10⁵)=4*10¹³

Assume a cost of electric power at $0.10 per kilowatt hour. For $1.00 one therefore produces:

11) 10*1000 w/kw*3600 sec/hour*4*10¹³=1.44*10²¹ atoms

From above we had the weight of C14=0.43*10²³ atoms per gram, therefore:

12) (0.43*10²³ atoms per gram)/(1.44*10²¹ atoms/$)=$30 per gram.

Of course this is the energy cost of transmutation only and for 100% efficient apparatus.

The following items are optimized experimentally and apparatus for the manufacture of C14 from N14 at the lowest cost is then constructed:

1. Pressures in input manifold 23, cavity 51/53 and output manifold 30.

2. Optimum orifices in gas distribution plates 24 and 31.

3. Precise frequency of microwave generator 34

4. The strength of magnetic H field 38 as established by the equipment described in FIG. 3.

5. The strength of the electric E field as established by DC supply 60.

5. The choice of the four possible combinations of directions of magnetic field H and electric field E.

### Advantages of the Invention

1) Electrical outputs useable for detecting and optimizing the production of C14.

2) Modular construction for ease in harvesting C14.

3) A method of controlling the purity of the carbon 14 from undesired carbon 12 by controlling the purity of the nitrogen from which it is made.

While the invention has been particularly shown and described with reference to preferred embodiments thereof, it will be understood by those skilled in the art that various changes in form and details may be made therein without departing from the spirit and scope of the invention.

1. Apparatus for transmutation of nitrogen 14 (N14) into carbon 14 (C14) comprising in combination:
a) a microwave cavity means resonant at the resonant frequency of N14 atoms,
b) said cavity means having a front half and a back half,
c) electrically insulating means between said front half and said back half of said microwave cavity,
d) microwave oscillator means at the resonant frequency of N14 atoms,
e) antenna means for exciting said cavity from said microwave oscillator,
f) pressure differential means for feeding N14 atoms in a first direction through said microwave cavity in a continuous process,
g) magnetic field means for holding N14 atoms in fixed magnetic positions in a second direction of selective polarity at right angles to said first direction,
h) dc power supply means to supply positive and negative voltages either side of a zero voltage center point, and
i) connection means for connecting said positive and negative voltages to front and back halves of said microwave cavity with selective choice of polarity thus providing electric fields within said cavity at right angles to said first and second directions for holding N14 atoms in fixed electric positions in a third direction thus producing the desired transmutation.

2. Apparatus as in claim 1 whereby said N14 is contained in a pressure tank.

3. Apparatus as in claim 1 further comprising in combination,
a) expansion chamber means for directing the flow of N14 gas into said microwave cavity,
b) first pressure regulating means for feeding N12 gas from said pressure tank into said input expansion chamber,
c) orifice plate means for providing a second pressure regulation between said expansion chamber and said microwave cavity,
d) collection chamber means for passing N14 gas onward for further pressure regulation,
e) microwave oscillator housing means for passing N14 gas from said microwave cavity into said collection chamber,
f) orifice plate means for providing a third pressure regulation between said microwave cavity and said microwave oscillator housing,
g) exhaust pump means for removing N14 gas from said apparatus,
h) fourth pressure regulating means for passing N14 gas from said collection chamber to said exhaust pump
whereby C14 flows by pressure differentials in a continuous process through apparatus for transmuting N14 into C14.

4. Apparatus as in claim 3 wherein said orifices are positioned on said orifice plates so as to form a laminar flow of N14 through said microwave cavity.

5. Apparatus means as in claim 3 further providing interchangeable orifice plate means having various diameter orifices
thus permitting experiments with a selection of pressure drops.

6. Apparatus as in claim 3 further including in combination:
a) pressure measuring means for said expansion chamber,
b) pressure measuring means for said microwave cavity,
c) pressure measuring means for said collection chamber
whereby pressures are usable for optimizing performance of the apparatus.

7. Apparatus as in claim 1 further comprising in combination:
a) measurement means for reading the current from said center point of said dc supply and a common point,
b) measurement means for reading the current from said microwave housing and said common point,
c) measurement means for reading of the current from said collection chamber and said common point,
d) measurement means for reading of the current from said common point and ground
whereby current measurements are usable in optimizing operation of said transmutation apparatus.

8. Apparatus as in claim 2 wherein said N14 is ultra-pure with respect to C12 contamination.

9. Apparatus as in claim 1 further comprising means for removing the half of said cavity having a positive polarity for harvesting of C14.

10. Apparatus for manufacture of carbon 14 (C14) from nitrogen 14 (N14) comprising in combination:
a) a microwave cavity means resonant at the resonant frequency of N14 atoms,
b) said cavity means having a front half and a back half,
c) electrically insulating means between said front half and said back half of said microwave cavity,
d) microwave oscillator means at the resonant frequency of N14 atoms,
e) antenna means for exciting said cavity from said microwave oscillator,
f) pressure differential means for feeding N14 atoms in a first direction through said microwave cavity in a continuous process,
g) magnetic field means for holding N14 atoms in fixed magnetic positions in a second direction of selective polarity at right angles to said first direction,
h) dc power supply means to supply positive and negative voltages either side of a zero voltage center point, and
i) connection means for connecting said positive and negative voltages to front and back halves of said microwave cavity with selective choice of polarity thus providing electric fields within said cavity at right angles to said first and second directions for holding N14 atoms in fixed electric positions in a third direction
thus producing the desired transmutation.

11. Apparatus as in claim 10 whereby said N14 is contained in a pressure tank.

12. Apparatus as in claim 10 further comprising in combination,
a) expansion chamber means for directing the flow of N14 gas into said microwave cavity,
b) first pressure regulating means for feeding N12 gas from said pressure tank into said input expansion chamber,
c) orifice plate means for providing a second pressure regulation between said expansion chamber and said microwave cavity,
d) collection chamber means for passing N14 gas onward for further pressure regulation,
e) microwave oscillator housing means for passing N14 gas from said microwave cavity into said collection chamber,
f) orifice plate means for providing a third pressure regulation between said microwave cavity and said microwave oscillator housing,
g) exhaust pump means for removing N14 gas from said apparatus,
h) fourth pressure regulating means for passing N14 gas from said collection chamber to said exhaust pump
whereby C14 flows by pressure differentials in a continuous process through apparatus for transmuting N14 into C14.

13. Apparatus as in claim 12 wherein said orifices are positioned on said orifice plates so as to form a laminar flow of N14 through said microwave cavity.

14. Apparatus as in claim 12 further including in combination:
a) pressure measuring means for said expansion chamber,
b) pressure measuring means for said microwave cavity,
c) pressure measuring means for said collection chamber
whereby pressures are usable for controlling the manufacture of C14.

15. Apparatus as in claim 10 further comprising in combination:
a) measurement means for reading the current from said center point of said dc supply and a common point,
b) measurement means for reading the current from said microwave housing and said common point,
c) measurement means for reading of the current from said collection chamber and said common point,
d) measurement means for reading of the current from said common point and ground
whereby current measurements are usable in optimizing operation of manufacture of C14.

16. Apparatus as in claim 11 wherein said N14 is ultra-pure with respect to C12 contamination.

17. Apparatus as in claim 10 further comprising means for removing the half of said cavity having a positive polarity for harvesting of C14.

18. A method of transmuting nitrogen 14 (N14) into carbon (C14) comprising:
a) providing microwave cavity means resonant at the resonant frequency of N(14) atoms,
b) providing pressure differential means continuously causing N(14) gas to flow through said microwave cavity means,
c) providing electromagnet means for causing a magnetic field to flow in a first direction through cross sections of said microwave cavity,
d) providing voltage difference means for causing an electric field to flow in a direction at right angles to said magnetic field,
e) providing microwave oscillator means for exciting said microwave cavity at the resonant frequency of N14 atoms
whereby N14 is transmuted into C14.
